(19) United States
(12) Patent Application Publication
(10) Pub. No.: US 2006/0095407 A1
(43) Pub. Date: May 4, 2006

(54) Methods and apparatus for adding parenthetical expression capability to a tabular query user interface

(75) Inventors: Kerry A. Ortega, Raleigh, NC (US); Gayle Colby Steinbugler, Raleigh, NC (US)

Correspondence Address: HARRINGTON & SMITH, LLP, 4 RESEARCH DRIVE, SHELTON, CT, 06484-6212, US

(73) Assignee: International Business Machines Corporation

(21) Appl. No.: 10/979,356

(22) Filed: Nov. 1, 2004

(51) Int. Cl. G06F 17/30

(52) U.S. Cl. 707/3

(57) ABSTRACT

The present invention concerns methods and apparatus for incorporating parenthetical expression capability in an interactive tabular query interface, wherein the interactive tabular query interface can be used to search computer resources like computer databases. The methods and apparatus of the present invention permit a user through the medium of a parenthetical-expression-capable tabular query interface both to group at least two logical expressions with a single level of parentheses and to embed parenthetical expressions within multi-level parenthetical expressions. The methods and apparatus of the present invention also permit a user to quickly and easily logically un-combine expressions that have been grouped using a parenthetical expression feature of a tabular query user interface made in accordance with the present invention. Further, the interactive tabular query interface also has a preview window for depicting dynamically a query as it is formulated.

### TECHNICAL FIELD

The present invention generally concerns table-based query systems for use in database management and more particularly concerns methods and apparatus for adding parenthetical expression capability to table-based query systems.

### BACKGROUND

The present invention concerns query systems for use in managing and searching database systems. In particular, a query-based system made in accordance with the prior art is depicted in FIG. 1. The query system depicted in FIG. 1 is based on a tree structure and hence is complicated, cumbersome and difficult to use.

For example, as queries become more complex, it becomes increasingly more difficult to proof queries for error. In addition, users typically desire the ability to make small modifications to an existing query in order to create a desired new query. In tree-based query systems similar to the one depicted in FIG. 1, it may be so difficult to determine the appropriate modification from examination of the tree structure that a user starts from the beginning.

A further problem encountered in tree-based query interfaces depicted in FIG. 1 is their inability to replicate all of the functionality of parenthetical expressions. Queries formulated in accordance with the tree-based interface depicted in FIG. 1 comprise operators (for example, “and”; “or”; “equal to”) and operands (for example, the name and identity of items being searched for in the database) but lack complete parenthetical expressions. Thus users of such interfaces must formulate particularly long and cumbersome expressions to duplicate the content of expressions formulated with parenthetical expressions.

In order to overcome some of the problems encountered in the art, table-based (hereinafter referred to as “tabular”) query interfaces have been proposed. Tabular query interfaces are more streamlined and easy to use. However, several problems have been encountered in tabular query interfaces. In particular, there has been no practical way to integrate parenthetical expression capability in known tabular query interfaces.

Since tabular query interface systems are used to formulate searches comprised of Boolean operators, it is imperative that parentheses, an important operator in Boolean expressions, be available in tabular query interface systems.

Accordingly, those skilled in the art desire improved tabular query interfaces. In particular, those skilled in the art desire tabular query interfaces that incorporate parenthetical expression capability. Further, those skilled in the art desire tabular query interfaces that seamlessly integrate parenthetical expression capability, making it simple to add and remove parentheses from expressions.

### SUMMARY OF THE PREFERRED EMBODIMENTS

The foregoing and other problems are overcome, and other advantages are realized, in accordance with the following embodiments of the present invention. The present invention comprises a computer system for displaying an interactive tabular query interface with parenthetical expression capability. In various embodiments of the present invention described herein, users create database queries with an interactive tabular query interface having parenthetical expression capability.

A first alternate embodiment of the present invention comprises a signal-bearing medium tangibly embodying a program of machine-readable instructions executable by a digital processing apparatus of a computer system to perform operations controlling a graphical user interface system, the operations comprising: displaying an interactive tabular query interface on a display of the computer system, wherein the interactive tabular query interface comprises: a table field for displaying logical expressions comprised of logical operators, operands and grouping elements, wherein the logical expressions, when taken together, comprise a search query; a logical operator entry facility to enter logical operators in the table field; an operand entry facility to enter operands in the table field, wherein the operands will be operated on by the operators; and an expression grouping facility to group at least two logical expressions entered in the table field together into a grouped expression using grouping elements; receiving commands corresponding to selections of logical operators, operands and grouping elements for display in selected locations in the table field; and displaying selected logical operators, operands and grouping elements in the selected locations in the table field.

A second alternate embodiment of the present invention comprises a computer system for displaying an interactive tabular query interface having expression grouping capability, the computer system comprising: at least one memory to store at least one program of machine-readable instructions, where the at least one program performs operations to display the interactive tabular query interface when executed; a computer display device for displaying the interactive tabular query interface; an input device for interacting with the interactive tabular user interface; and at least one processor coupled to the at least one memory, computer display and input device, where the at least one processor performs at least the following operation when the at least one program is executed: displaying the interactive tabular query interface, where the interactive tabular query interface comprises: a table field for displaying logical expressions comprised of logical operators, operands and grouping elements, wherein the logical expressions, when taken together, comprise a search query; a logical operator entry facility to enter logical operators in the table field; an operand entry facility to enter operands in the table field, wherein the operands will be operated on by the operators; and an expression grouping facility to combine at least two logical expressions entered in the table field into a grouped expression using grouping elements.

A third alternate embodiment of the present invention comprises: a user interface control system method comprising: displaying an interactive tabular query interface having expression grouping capability, the interactive tabular query interface comprising: a table field for displaying logical expressions comprised of logical operators, operands and grouping elements, wherein the logical expressions, when taken together, comprise a search query; a logical operator entry facility to enter logical operators in the table field; an operand entry facility to enter operands in the table field, wherein the operands will be operated on by the operators; and a grouping element entry facility to combine at least two logical expressions entered in the table field into a grouped expression using grouping elements; receiving commands corresponding to selections of logical operators, operands and grouping elements for display in selected locations in the table field; and displaying selected logical operators, operands and grouping elements in the selected locations in the table field.

Thus, it is seen that embodiments of the present invention overcome limitations of the prior art. Known interactive tabular query interfaces do not include parenthetical expression capability. This limitation makes it difficult if not impossible for users of known interactive tabular query interfaces to formulate complex Boolean expressions comprised of numerous embedded parenthetical expressions for use in searching computer databases. Without a parenthetical expression capability, a user would have to formulate complex logical expressions with less user-friendly Boolean combinatorial operators like “and” or “or” in lengthy strings which would make it very burdensome for a user to proof the complex logical expression for error.

In contrast, the foregoing embodiments of the present invention through the medium of a parenthetical-expression-capable interactive tabular query interface enable a user to formulate complex logical expressions both by grouping at least two logical sub-expressions together with a single level of parentheses and by joining numerous logical sub-expressions together with multiple levels of parentheses. The preview display field of the present invention significantly simplifies the formulation of complex logical expressions by providing dynamic and real-time feedback to show the complex logical expression as it is formulated by a user of the interactive tabular query interface. The methods and apparatus of the present invention also greatly simplify the editing of complex logical expressions by providing functionality for a user to logically un-combine sub-expressions that have been grouped together using the parenthetical expression feature.

The “find a parenthetical expression” feature of the present invention also significantly simplifies the handling of complex logical expressions formulated with a parenthetical-expression-capable interactive tabular query interface. This is accomplished by permitting a user both to find a parenthetical expression within an overall expression and to toggle between various levels of a complex logical expression. The latter capability permits a user to view portions of an expression that are of interest.

In conclusion, the foregoing summary of the alternate embodiments of the present invention is exemplary and non-limiting. For example, one of ordinary skill in the art will understand that one or more aspects or steps from one alternate embodiment can be combined with one or more aspects or steps from another alternate embodiment to create a new embodiment within the scope of the present invention.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 depicts a tree-based query interface made in accordance with the prior art;

FIG. 2 depicts an interactive tabular query interface that allows a user to add or remove multiple levels of parentheses made in accordance with the present invention;

FIG. 3 depicts a parentheses function of an interactive tabular query interface operating in accordance with one embodiment of the present invention;

FIG. 4 depicts the parentheses function of an interactive tabular query interface operating in accordance with one embodiment of the present invention;

FIG. 5 depicts the parentheses function of an interactive tabular query interface operating in accordance with one embodiment of the present invention;

FIG. 6 depicts the parentheses function of an interactive tabular query interface operating in accordance with one embodiment of the present invention;

FIG. 7 depicts a block diagram of a computer system suitable for practicing the methods and apparatus of the present invention;

FIG. 8 depicts an embedded parentheses function of an interactive tabular query interface operating in accordance with one embodiment of the present invention;

FIG. 9 depicts the embedded parentheses function of an interactive tabular query interface operating in accordance with one embodiment of the present invention;

FIG. 10 depicts the embedded parentheses function of an interactive tabular query interface operating in accordance with one embodiment of the present invention;

FIG. 11 depicts the embedded parentheses and find parenthetical expression functions of an interactive tabular query interface operating in accordance with one embodiment of the present invention;

FIG. 12 depicts the find parenthetical expression function of an interactive tabular query interface operating in accordance with one embodiment of the present invention;

FIG. 13 depicts the find parenthetical expression function of an interactive tabular query interface operating in accordance with one embodiment of the present invention;

FIG. 14 depicts the find parenthetical expression function of an interactive tabular query interface operating in accordance with one embodiment of the present invention;

FIG. 15 depicts the find parenthetical expression function of an interactive tabular query interface operating in accordance with one embodiment of the present invention;

FIG. 16 depicts the find parenthetical expression function of an interactive tabular query interface operating in accordance with one embodiment of the present invention;

FIG. 17 depicts a delete parentheses function of an interactive tabular query interface operating in accordance with one embodiment of the present invention;

FIG. 18 depicts the delete parentheses function of an interactive tabular query interface operating in accordance with one embodiment of the present invention;

FIG. 19 depicts the delete parentheses function of an interactive tabular query interface operating in accordance with one embodiment of the present invention;

FIG. 20 depicts the delete parentheses function of an interactive tabular query interface operating in accordance with one embodiment of the present invention;

FIG. 21 depicts a parentheses function of an interactive tabular query interface operating in accordance with another embodiment of the present invention;

FIG. 22 depicts the parentheses function of an interactive tabular query interface operating in accordance with another embodiment of the present invention;

FIG. 23 depicts the parentheses and find parenthetical expression functions of an interactive tabular query interface operating in accordance with another embodiment of the present invention;

FIG. 24 depicts an embedded parentheses function of an interactive tabular query interface operating in accordance with another embodiment of the present invention;

FIG. 25 depicts the embedded parentheses function of an interactive tabular query interface operating in accordance with another embodiment of the present invention; and

FIG. 26 depicts the find parenthetical expression and embedded parentheses functions of an interactive tabular query interface operating in accordance with another embodiment of the present invention.

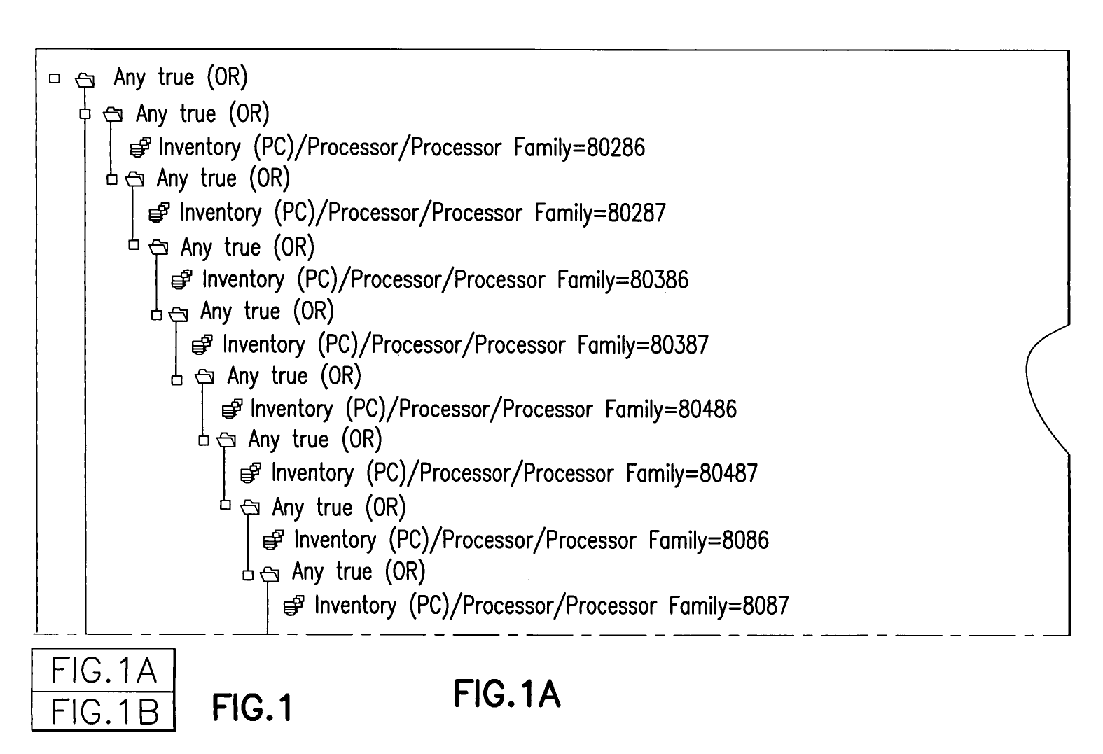

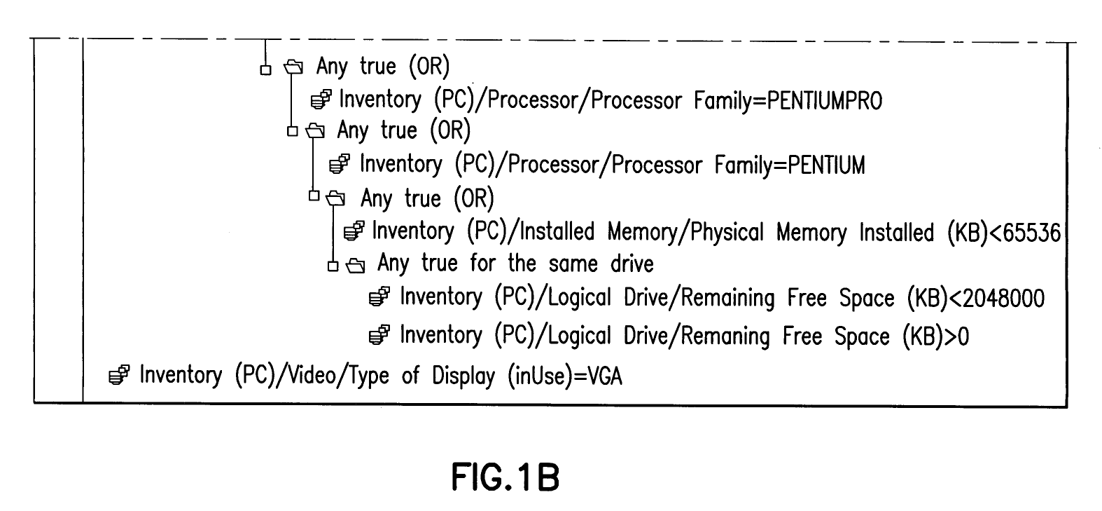

### DETAILED DESCRIPTION OF THE PREFERRED EMBODIMENTS

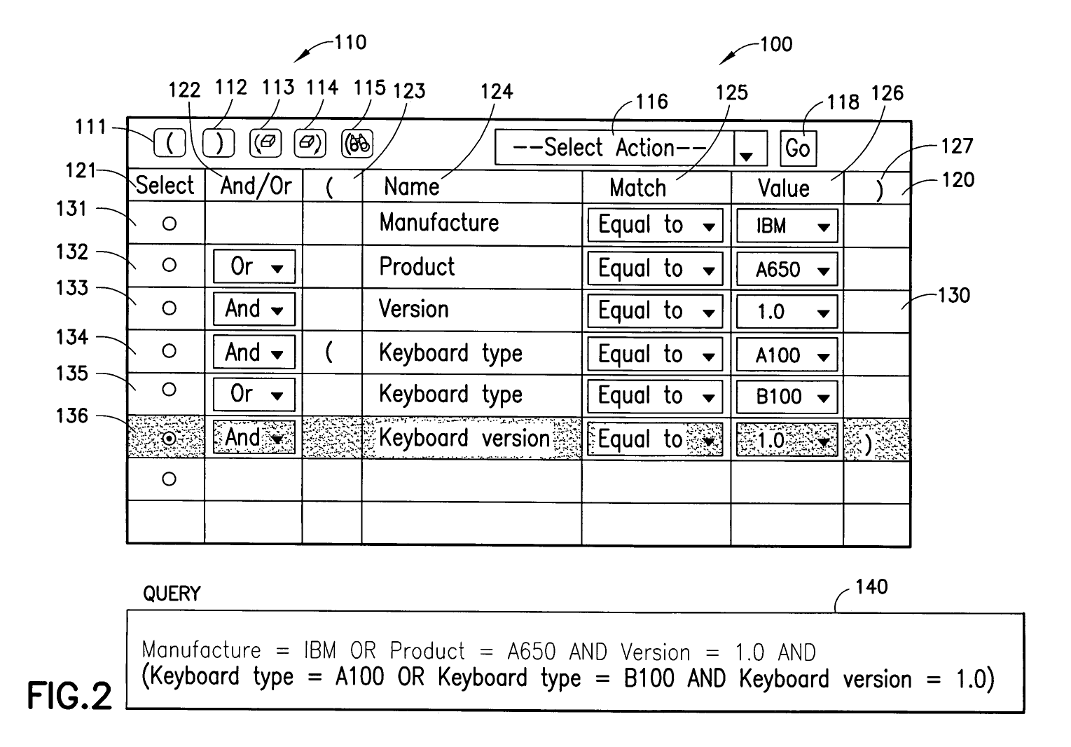

As depicted in FIG. 2, an interactive tabular query system made in accordance with an alternate embodiment of the present invention comprises an interactive tabular query interface 100 for display on a display device of a computer system. The interactive tabular query interface 100 comprises a parentheses tool bar 110; a drop-down action menu 116 and associated “go” button 118; a column title row 120; a table field 130; and a preview display area 140 with logical expression display capability.

The table field 130 is a two-dimensional matrix comprised of cells, wherein each cell in the two-dimensional table will display a logical operator or operand as a specific query is formulated. Each row of the matrix comprising the table field 130 is available for displaying a component expression of an overall logical expression corresponding to a database query. The component expressions of an overall logical expression are formulated using interface facilities that allow a user to specify logical operators and operands. The facilities for specifying operators and operands are organized by columns. In the interactive tabular query interface depicted in FIG. 2, there are columns corresponding to logical operators and columns corresponding to operands.

For example, there is a column 122 comprised of cells where a user can select an “and” or an “or” for specifying combinatorial operators like “and” or “or”; and a match column 125 for specifying operators indicating identity (or the lack thereof), such as, “equal to”. Similarly, there are columns for specifying operands that will be operated on by the operators, for example, “Name” 124 and “Value” 126.

In the example depicted in FIG. 2, a logical expression for querying a database has already been formulated and occupies rows 131, 132, 133, 134, 135, and 136 of the table field 130. In addition, the query is also displayed in the preview area 140 in typical logical expression format comprising logical operators, operands and parentheses. As is apparent from the example, the parenthetical expression capability of the interactive tabular query interface has been used to create the parenthetical expression “(Keyboard type=A100 OR Keyboard type=B100 AND Keyboard version=1.0)” comprised of component expressions.

The search query shown in the preview area 140 was formulated by entering a series of component logical expressions which, when taken together, comprise the search query. In the example depicted in FIG. 2, a user would enter the search query one component expression at a time. In order to enter a component expression, a user would select a radio button in column 121 in the row, for example, 131, where the user would like the expression to begin. Moving left to right in row 131, the user would select the desired cell value (either an operator or an operand) using the functionality of the interactive tabular query interface depicted in FIG. 2. In the interface depicted in FIG. 2, combinatorial operators (and/or) are selected with a drop-down list. A user desiring to select the combinatorial operator “or” for the cell position corresponding to the intersection of row 132, column 122, would place the cursor over the drop-down list icon in the cell and then highlight the desired combinatorial operator (“or”) in the drop-down list to select it. Of course, one of ordinary skill in the art will understand that other combinations of cursor actions and mouse clicks can be used to select operators or operands. The process continues from row to row until all the component expressions comprising the overall expression have been entered.

In the prior art, there is no known way to represent parenthetical, or “grouped” expressions using an interactive tabular query interface. The embodiment depicted in FIG. 2 depicts one apparatus made in accordance with the present invention which permits a user to formulate parenthetical, or “grouped” expressions using a parenthetical expression (expression grouping) capability incorporated in the interactive tabular query interface. As shown in FIG. 2, a user has created a database query using the interactive tabular query system which comprises, in part, a grouped expression. The grouped expression corresponds to (Keyboard type=A100 OR Keyboard type=B100 AND Keyboard version=1.0). This grouped expression was created by adding an open parenthesis in the table field position of row 134 reserved for open parentheses and a close parenthesis in the table field position of row 136 reserved for close parentheses. The parentheses were added to the table field positions by using the parentheses toolbar 110. Although parentheses are depicted in the embodiment of FIG. 2, other grouping elements can be used to combine expressions into parenthetical, or “grouped”, expressions, for example, brackets or braces. This list is non-limiting and the present invention, as claimed, covers any grouping element operating in accordance with these teachings.

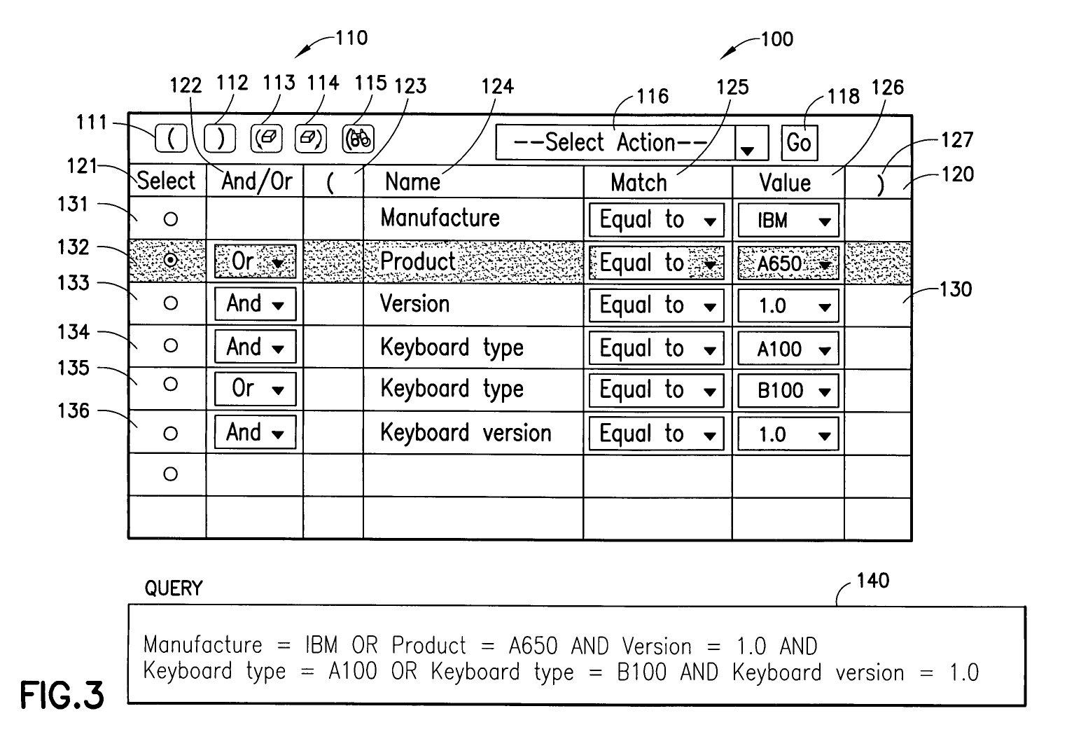

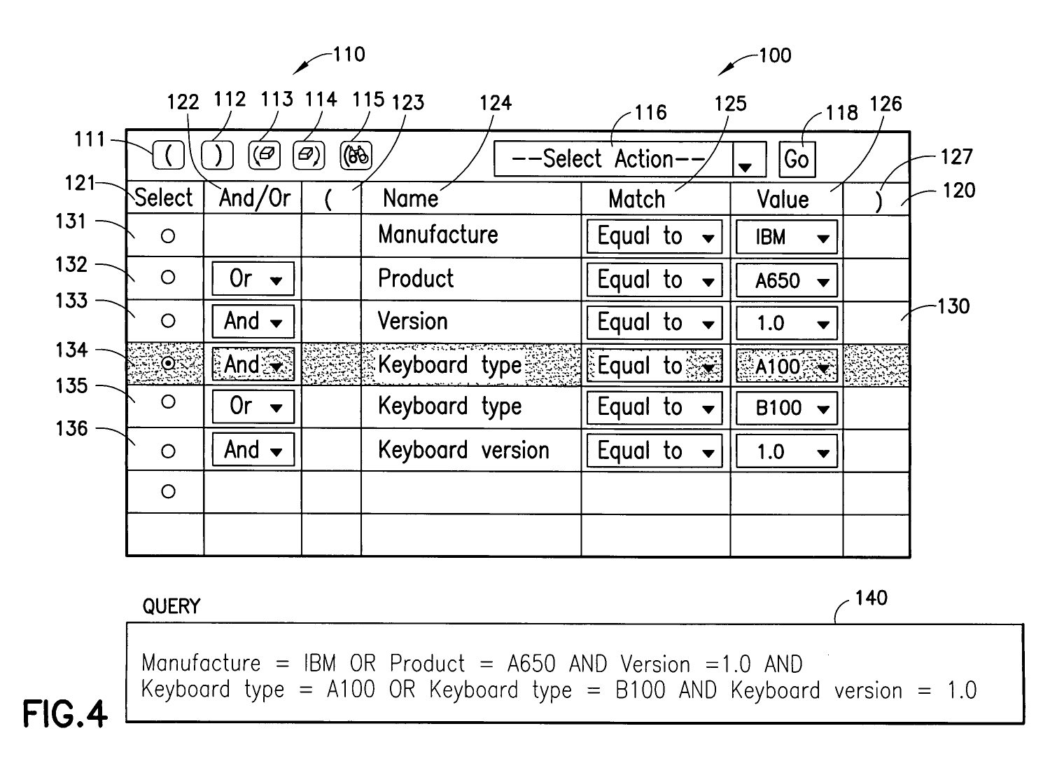

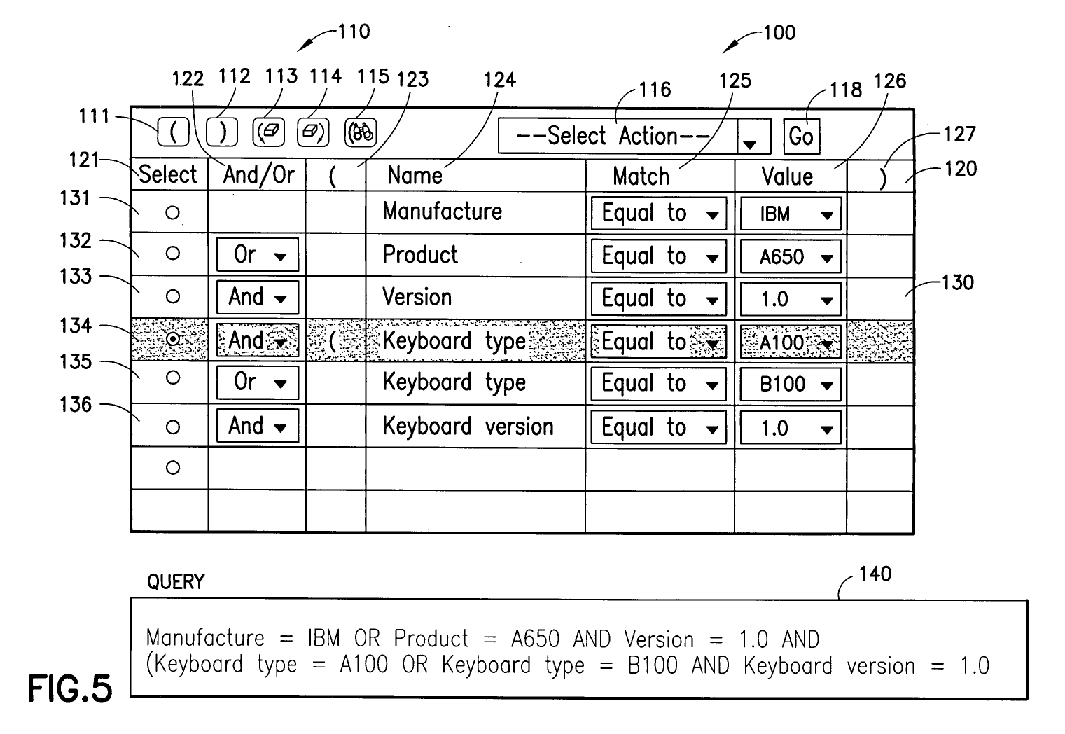

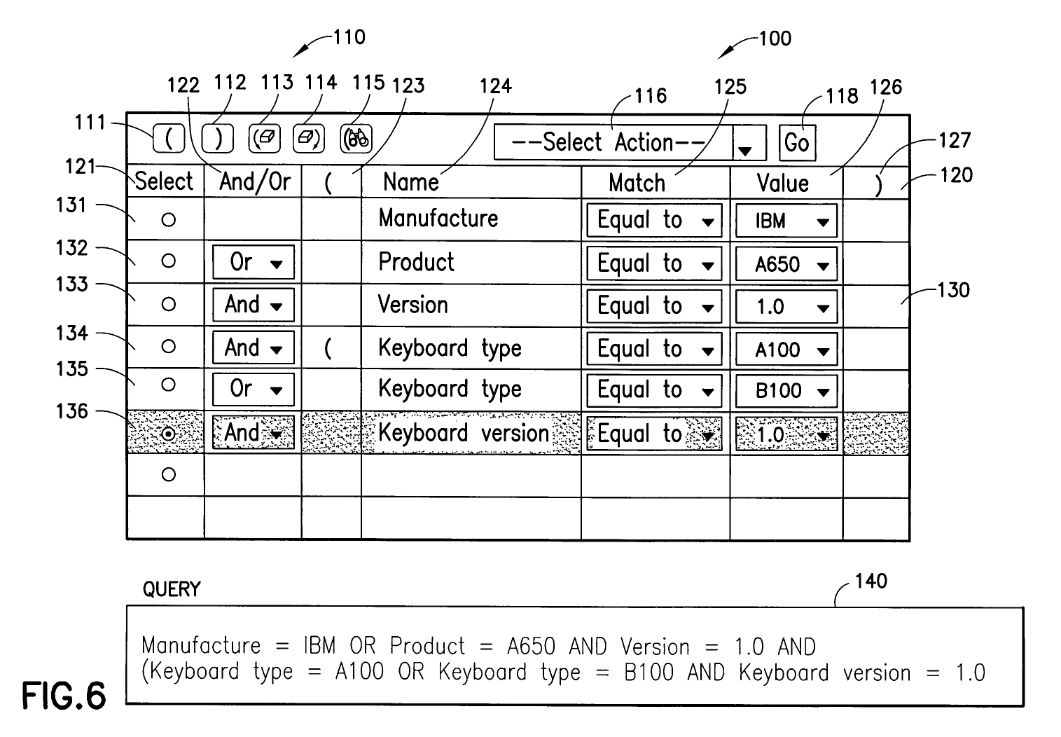

The steps followed to create the parenthetical expression depicted in FIG. 2 will now be described. FIG. 3 depicts the state of the expression before any action to create a parenthetical expression has been taken. All of the component expressions which will comprise the overall expression have been entered in the table field 130. To add the parenthetical expression to the expression depicted in FIG. 3, a user would select the row where the parenthetical expression will begin with the radio button in column 121 (for example, row 134) as shown in FIG. 4 and then select the open-parentheses icon 111 in the parentheses toolbar 110. An open-parenthesis then appears in the cell position corresponding to the intersection of column 123 and row 134 as shown in FIG. 5. In order to complete the expression, a user would select the row where the close-parenthesis should appear. This is shown in FIG. 6, where the user has selected row 136 with the radio button in column 121. The user next selects the close-parenthesis icon 112 in the toolbar 110, and a close-parenthesis then appears in the cell position at the intersection column 127 and row 136 as depicted in FIG. 2.

FIG. 2 depicts another feature of the present invention—the ability to find an individual parenthetical expression within an overall expression. This is accomplished by selecting the parenthesis-binocular icon 115 in the parentheses toolbar 110. After the parenthesis-binocular icon 115 has been selected, the parenthetical expression is then highlighted. In FIG. 2, the parenthetical expression “(Keyboard type=A100 OR Keyboard type=B100 AND Keyboard version=1.0)” appears in boldface. One of ordinary skill in the art will understand that other means can be selected to draw attention to or highlight the parenthetical expression, for example, making the expression appear as a “negative” of the original parenthetical expression within an overall expression that otherwise appears as a “positive” image. In addition, in alternate embodiments the highlighting feature could be used automatically to assist drafting activity. For example, a just-completed parenthetical expression could appear momentarily in boldface automatically as soon as the parenthetical expression is completed. After a short period of time, the boldfacing would disappear.

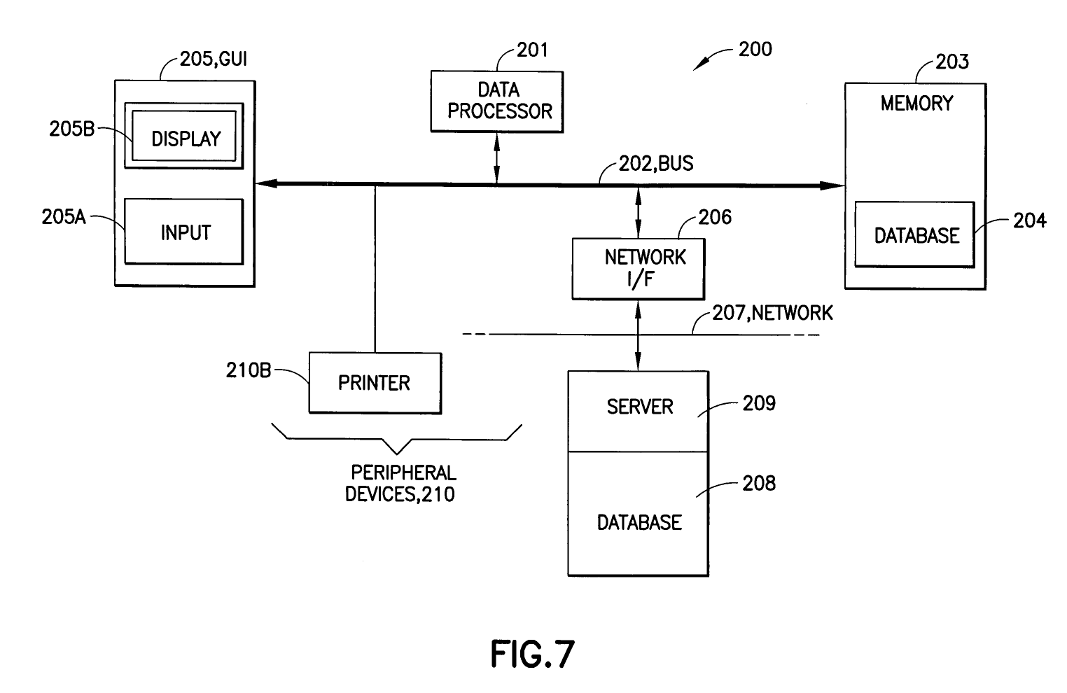

A computer system for practicing the methods of the present invention is depicted in simplified form in FIG. 7. The data processing system 200 includes at least one data processor 201 coupled to a bus 202 through which the data processor may address a memory sub-system 203, also referred to herein simply as “memory” 203. The memory 203 may include RAM, ROM and fixed and removable disks and/or tape. The memory 203 is assumed to store at least one program comprising instructions for causing the processor 201 to execute methods in accordance with the present invention. Also stored in memory 203 is at least one database 204 containing information that may be searched with database queries formulated with the methods and apparatus of the present invention.

The data processor 201 is also coupled through the bus 202 to a user interface, preferably a graphical user interface (“GUI”) 205 that includes a user input device 205A, such as one or more of a keyboard, a mouse, a trackball, a voice recognition interface, as well as a user display device 205B, such as a high resolution graphical CRT display terminal, a LCD display terminal, or any suitable display device. With these input/output devices, a user can formulate complex logical expressions by viewing and interacting with a parenthetical-expression-capable interactive tabular query interface displayed on the display device 205B.

The data processor 201 may also be coupled through the bus 202 to a network interface 206 that provides bidirectional access to a data communications network 207, such as an intranet and/or the internet. In various embodiments of the present invention, a database 208 of information can be accessed over the internet and a complex logical query can be applied to the database 208.

In general, these teachings may be implemented using at least one software program running on a personal computer, a server, a microcomputer, a mainframe computer, a portable computer, an embedded computer, or by any suitable type of programmable data processor 201. Further, a program of machine-readable instructions capable of performing operations in accordance with the present invention may be tangibly embodied in a signal-bearing medium, such as, a CD-ROM.

In the prior art, there is no known way to represent embedded (“nested”) parenthetical expressions using an interactive tabular query interface. The interactive tabular query interface of the present invention also advantageously permits a user to formulate logical expressions that include embedded or nested parenthetical expressions, thus overcoming this limitation of the prior art. Embedded parenthetical expressions are created in similar fashion to parenthetical expressions.

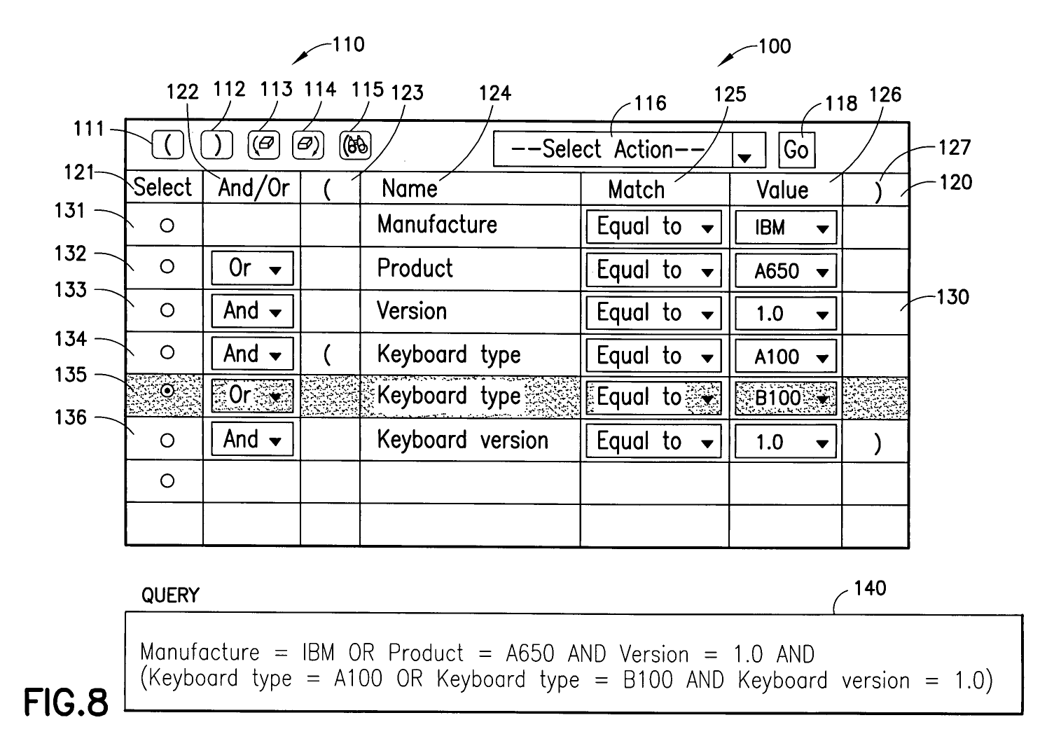

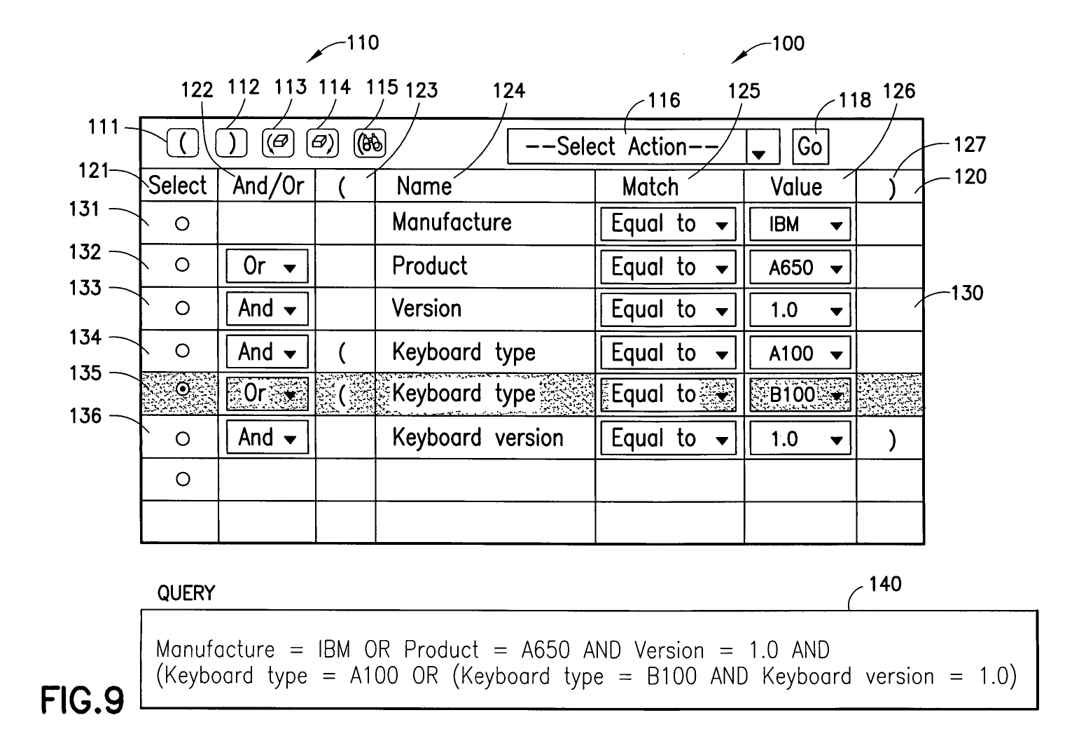

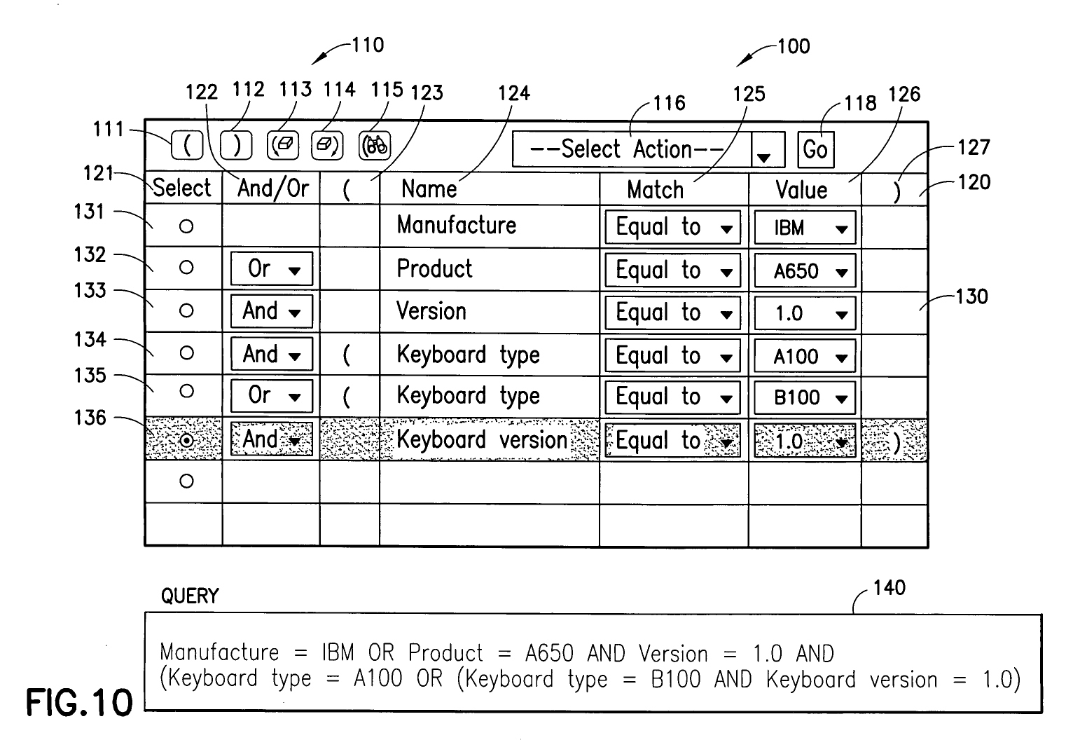

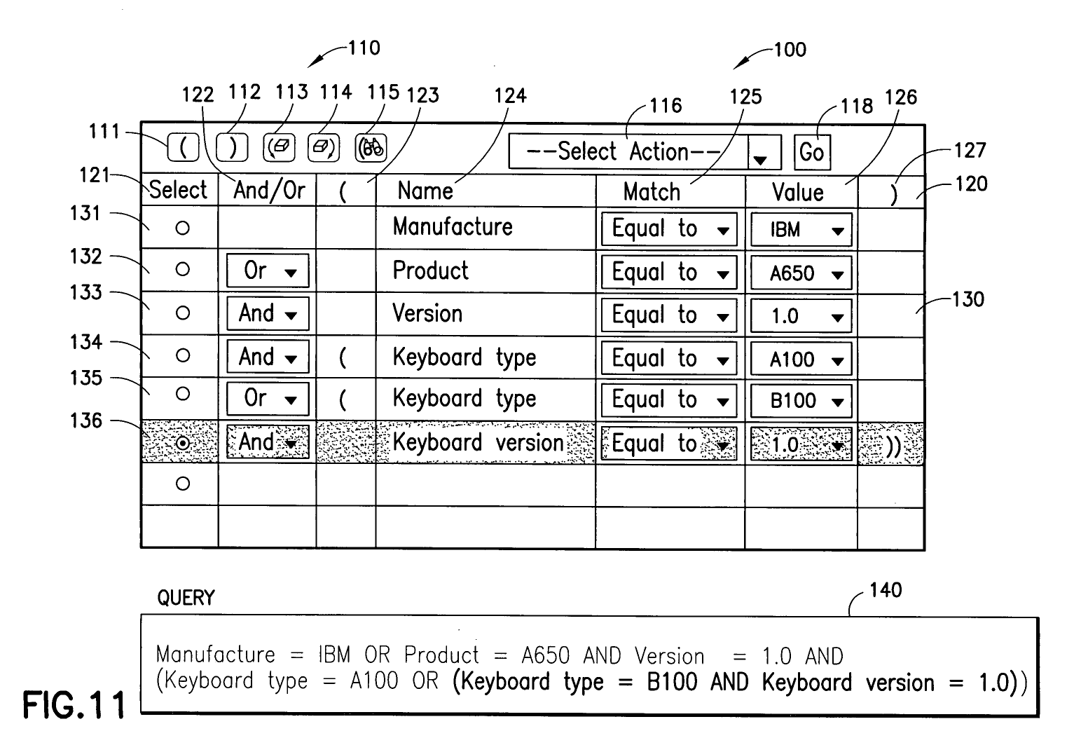

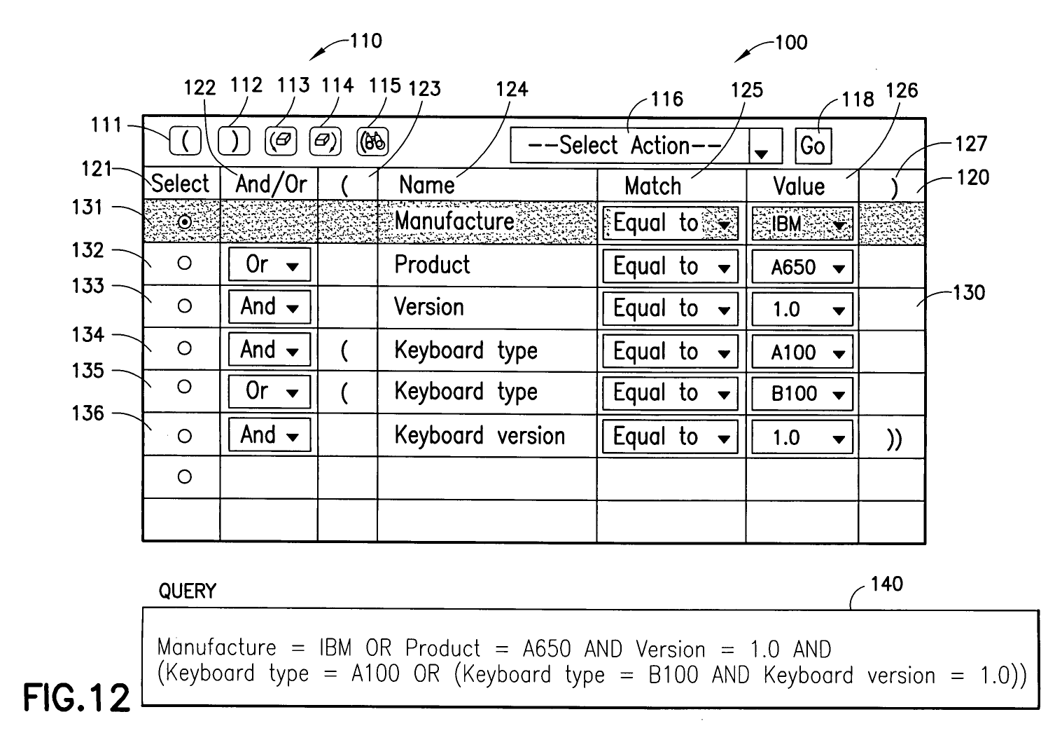

As depicted in FIG. 8, the user selects in which row the embedded parenthetical expression should begin; in this example the radio button in row 135 is selected. Next, the user selects the open-parenthesis icon 111 in the parentheses toolbar 110, after which an open parenthesis appears in the open parenthesis cell position in row 135 as depicted in FIG. 9. Then, the user selects the row in which the close parenthesis should appear. In the present example, this is depicted in FIG. 10, where the radio button in row 136 has been selected. Next, the user selects the close parenthesis icon 112 from the parentheses toolbar 110. A second close parenthesis then appears in the close parenthesis cell in row 136 as shown in FIG. 11. In this particular example, the find parenthetical expression function has also been used. After completing the embedded parenthetical expression “(Keyboard type=B100 AND Keyboard version=1.0)”, the user has selected the parenthesis-binocular icon 115 from the parentheses toolbar so that the embedded parenthetical expression appears highlighted. When the radio button in another row is selected, the highlighting of the expression disappears as depicted in FIG. 12. The boldfacing of the embedded parenthetical expression has now disappeared.

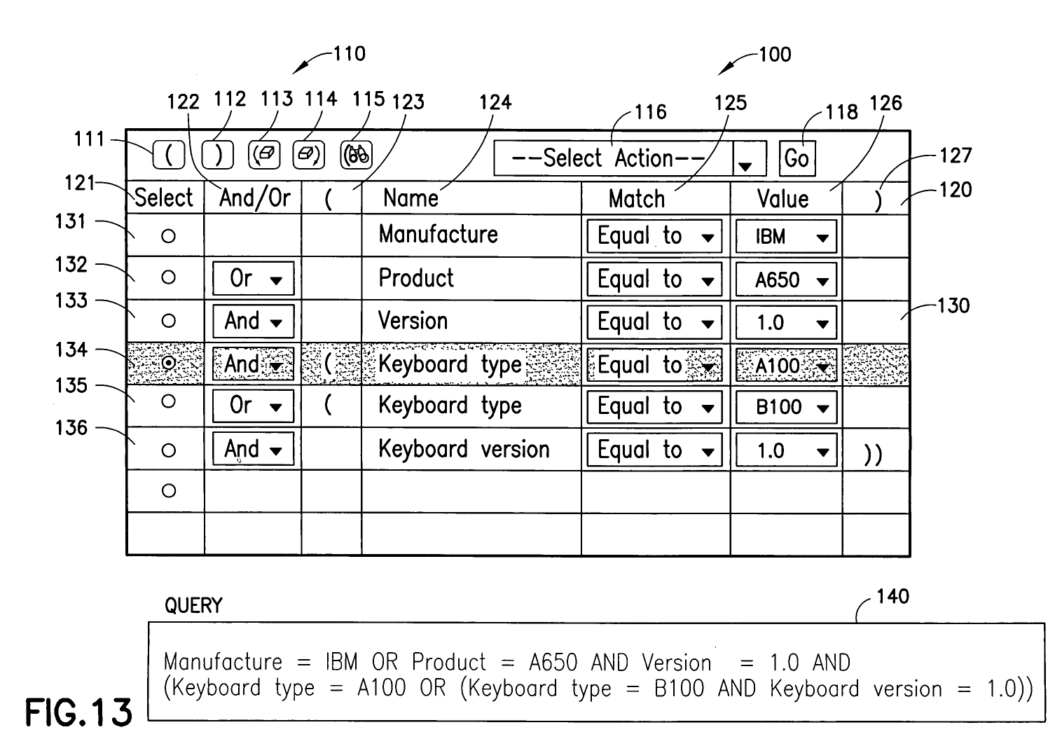

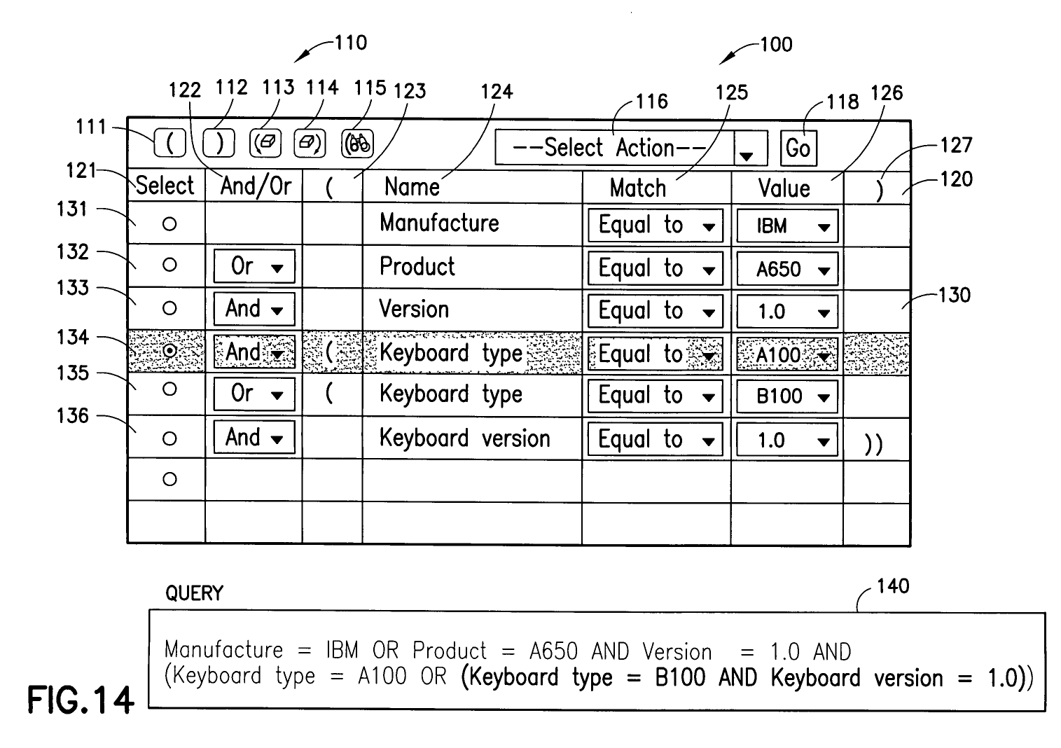

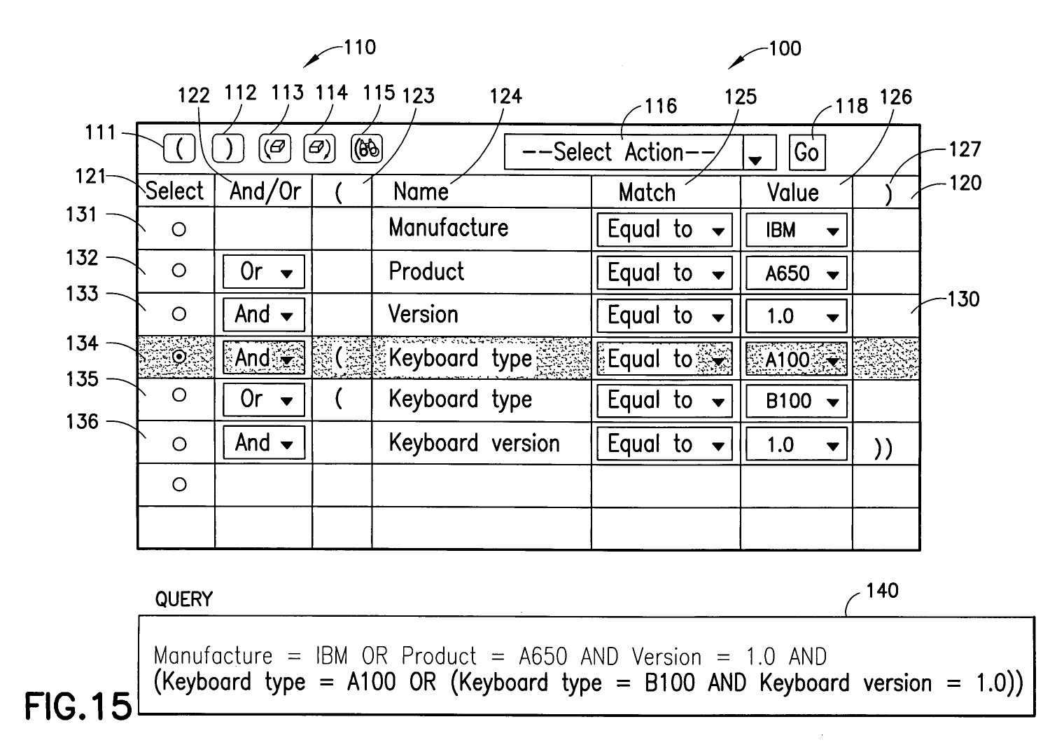

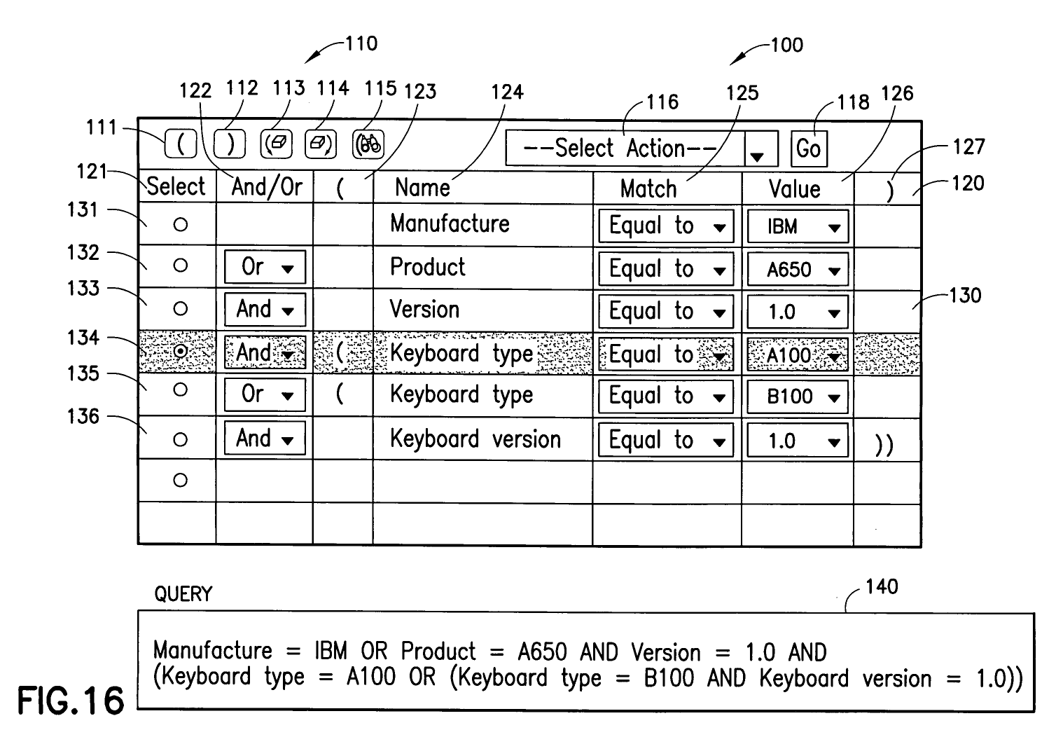

Further details associated with the find or locate parenthetical expression feature are shown in FIGS. 13-16. In the example beginning in FIG. 13, the user desires to locate parenthetical expressions beginning in row 134 within the overall expression shown in the preview window 140. Accordingly, the user selects row 134 using the radio button in row 134. Next, the user selects the parenthesis-binocular icon 115 in the parentheses toolbar 110. This causes the parenthetical expression beginning in row 135 to be highlighted, as shown in the preview window 140 depicted in FIG. 14. If the user continues to select the parenthesis-binocular icon in the parentheses toolbar 110, the next level in which the parenthetical expression is included will be boldfaced as shown in FIG. 15. If the user selects the parenthesis binocular icon 115 a third time, the next level up will be highlighted as shown in FIG. 16. This next level corresponds to the overall expression.

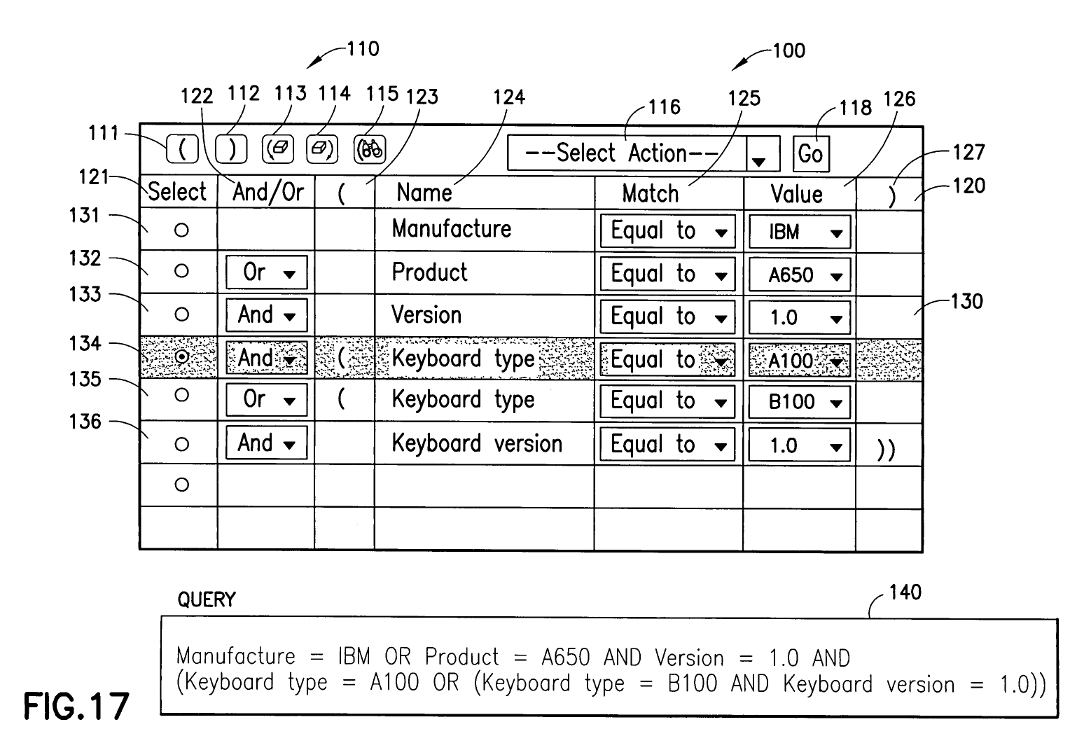

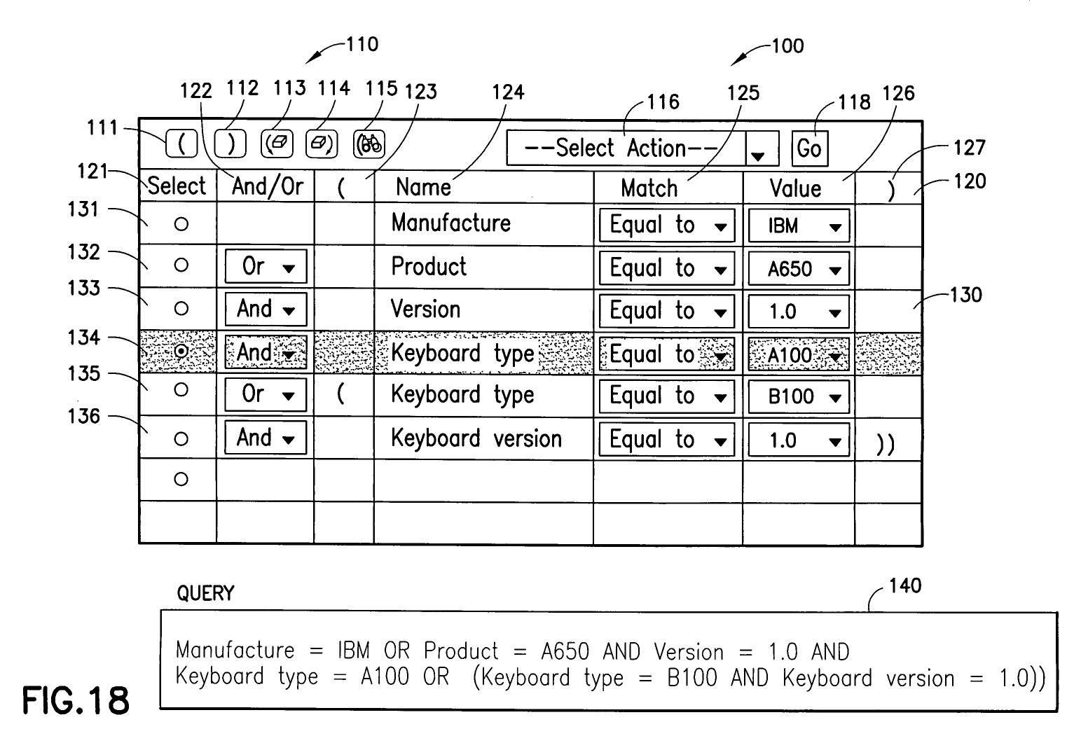

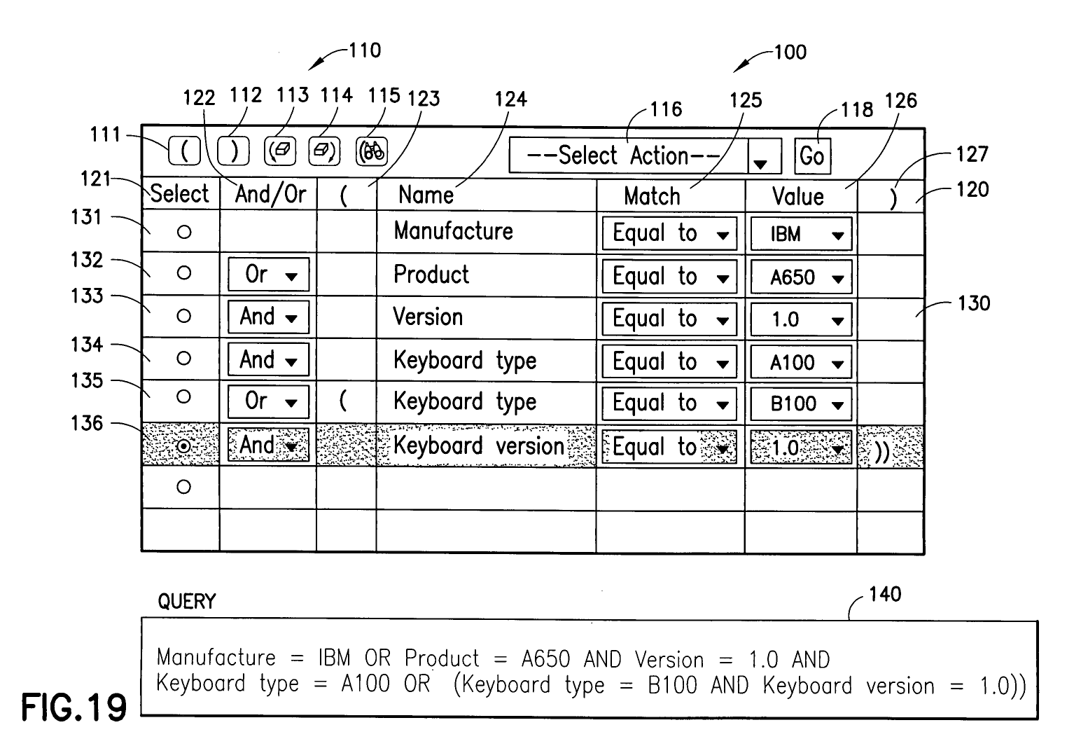

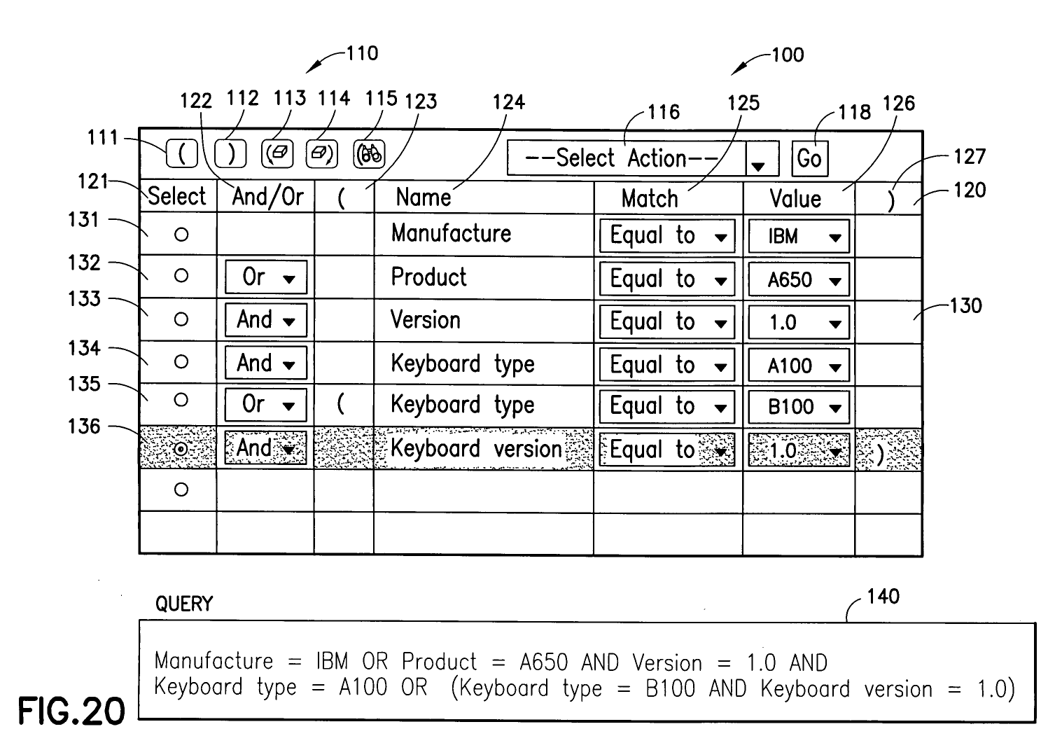

The next feature to be described is the delete parenthesis feature depicted in FIGS. 17-20. The delete parenthesis feature operates in a similar fashion to the add parenthesis features described in the previous embodiments. First, the user selects the row where the parenthetical expression to be deleted begins. In the example in FIG. 17, the parenthesis to be deleted is in row 134, so the radio button in row 134 is selected. Next, the user selects the clear-open-parenthesis icon 113 in the parentheses toolbar 110. This clears the open parenthesis in row 134 as shown in FIG. 18. In order to finish deleting the parenthetical expression, the user must delete the close parenthesis that completed the expression. The user accomplishes this first by selecting row 136 with the radio button as shown in FIG. 19, and then by selecting the clear-close-parenthesis icon 114. As shown in FIG. 20, one of the close-parenthesis in the close-parenthesis cell in row 136 has now disappeared, meaning that the user has completed clearing the parenthetical expression which began in row 134.

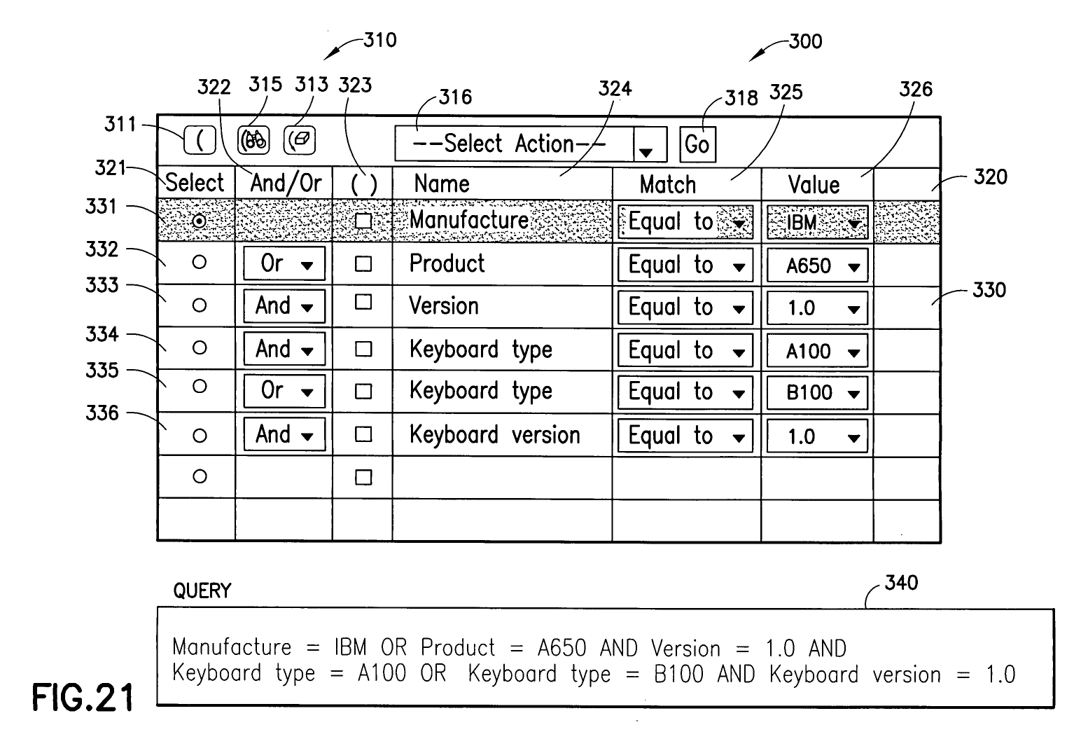

Another embodiment of an interactive tabular query system is depicted in FIG. 21. The interactive tabular query system comprises an interactive tabular query interface 300 for display on a display device of a computer system. The interactive tabular query interface 300 comprises a toolbar 310; a drop-down action menu 316 and associated “Go” button 318; a column title row 320; a table field 330; and a preview display area 340. The table field 330 is a two-dimensional matrix wherein each cell position in the two-dimensional matrix will display a logical operator or operand as a specific query is formulated. Each row of the matrix comprising the table field 330 is available for displaying a component of an overall logical expression corresponding to a search query. The components of a search query are formulated using facilities that allow the user to specify logical operators and operands. For example, in the interactive tabular query interface 300 depicted in FIG. 21, there is a column 322 entitled “And/Or” for specifying these combinatorial operators and a column 322 entitled “Match” for specifying logical operators indicating identity, the lack of identity, or relative magnitude (such, “equal to”; “not equal to”; “less than” or greater than”). In addition, there are columns 324, 326 for specifying operands that will be operated on by operators, such as, “Name” 324 and “Value” 326.

In the alternate embodiment depicted in FIG. 21, parentheses are added in a different manner than in the embodiment depicted in FIG. 2. In the alternate embodiment depicted in FIG. 21, a checkbox column 323 with the heading “( )” is used to specify the scope of a parenthetical expression, or to view it once it has been set. In the particular embodiment depicted in FIG. 21, the grouping element used to signify which expressions should be, or have been, joined in a “grouped” expression are checks in the checkbox column 323.

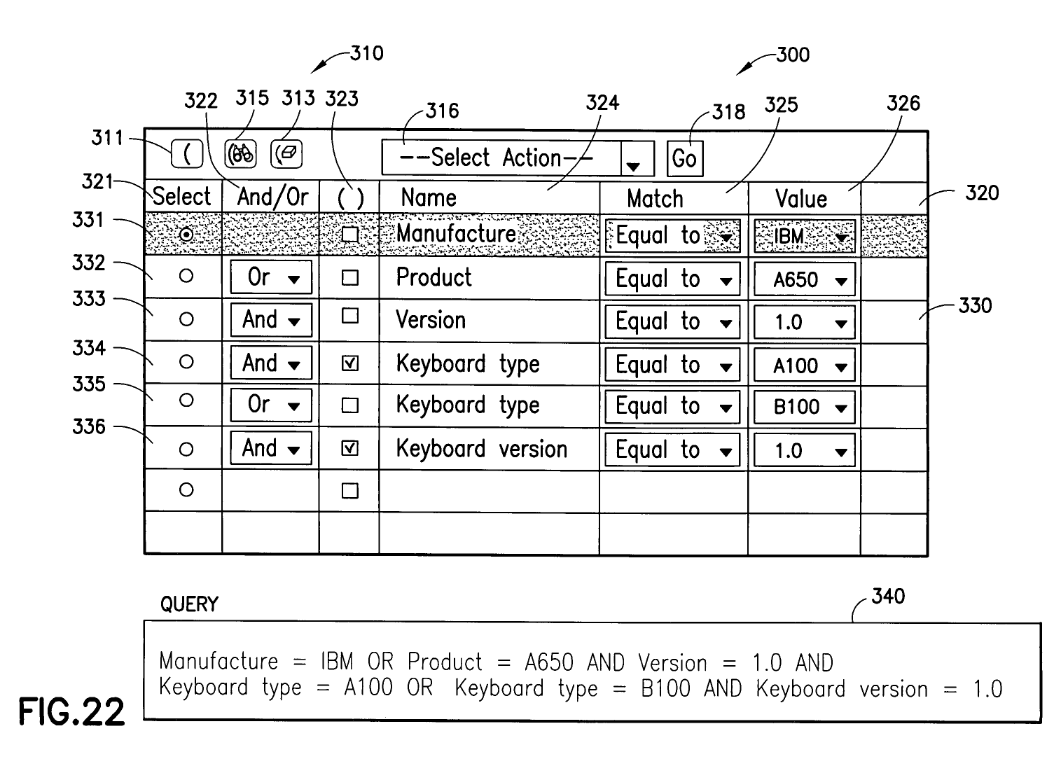

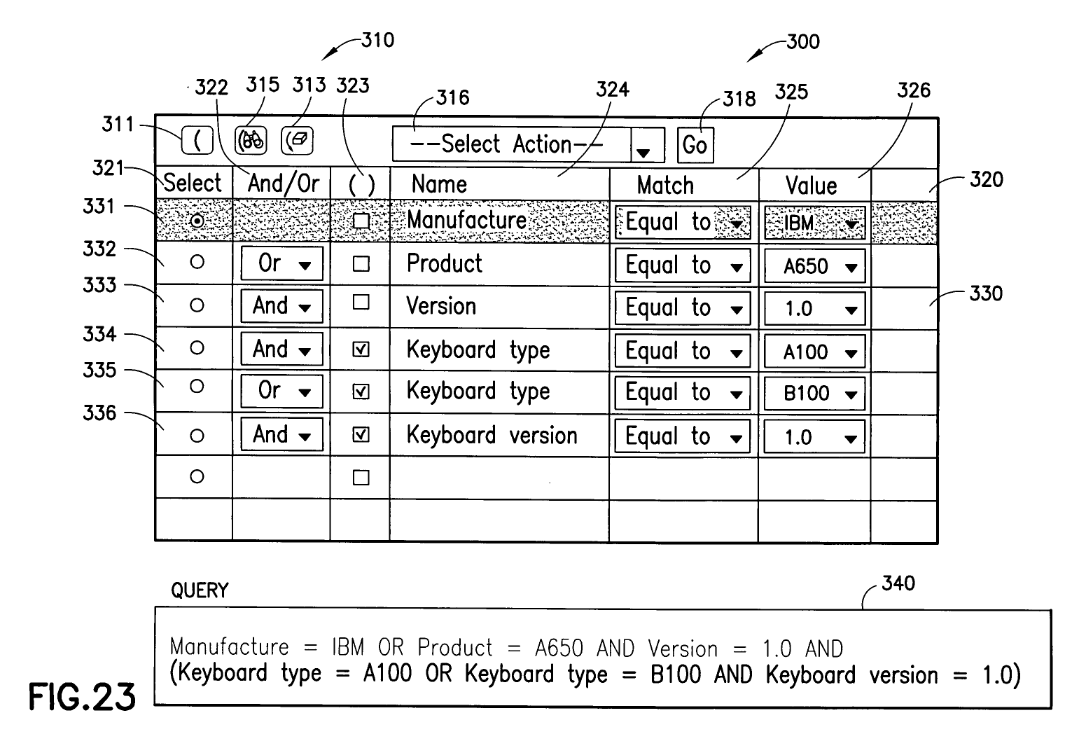

FIGS. 22-23 demonstrate how the component expressions “Keyboard type=A100 OR Keyboard type=B100 AND Keyboard version 1.0” can be combined into the parenthetical, or “grouped” expression (Keyboard type=A100 OR Keyboard type=B100 AND Keyboard version 1.0) with the embodiment depicted in FIG. 21. As shown in FIG. 22, a user would achieve this transformation by clicking the check boxes in the parenthesis checkbox column 323 for the first and last component expressions that will comprise the parenthetical expression, and then by selecting the add parentheses icon 311 from the parentheses tool bar 310. The new expression, including a parenthetical expression, is depicted in the preview display window in FIG. 23. As is apparent, the parentheses checkbox in row 335 also displays a check to indicate that the expression in row 335 is included in the parenthetical expression. This can be accomplished automatically by software whenever an intermediate expression like that in row 335 is detected as having been included in a parenthetical expression. Alternatively, a user could have checked all three boxes in rows 334, 335 and 336, in order froth top to bottom, to accomplish the same result. In the particular example depicted in FIG. 23, the user also has selected the find parenthetical expression function with the parenthesis-binocular icon 315 to highlight the position of the new parenthetical expression within the overall expression.

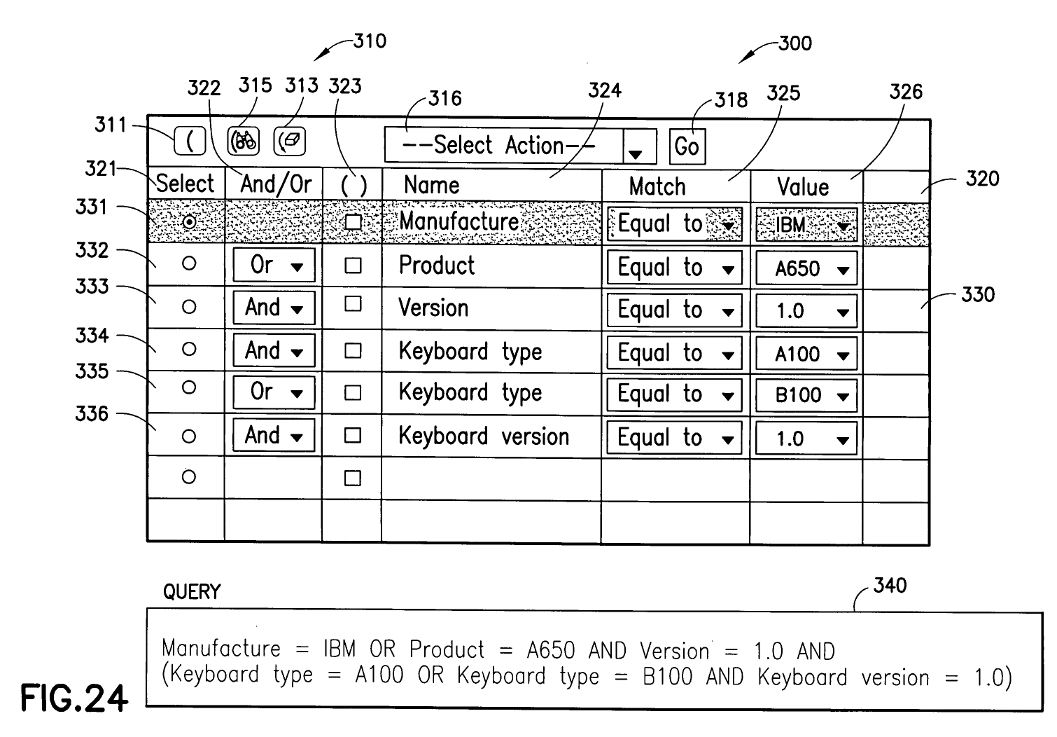

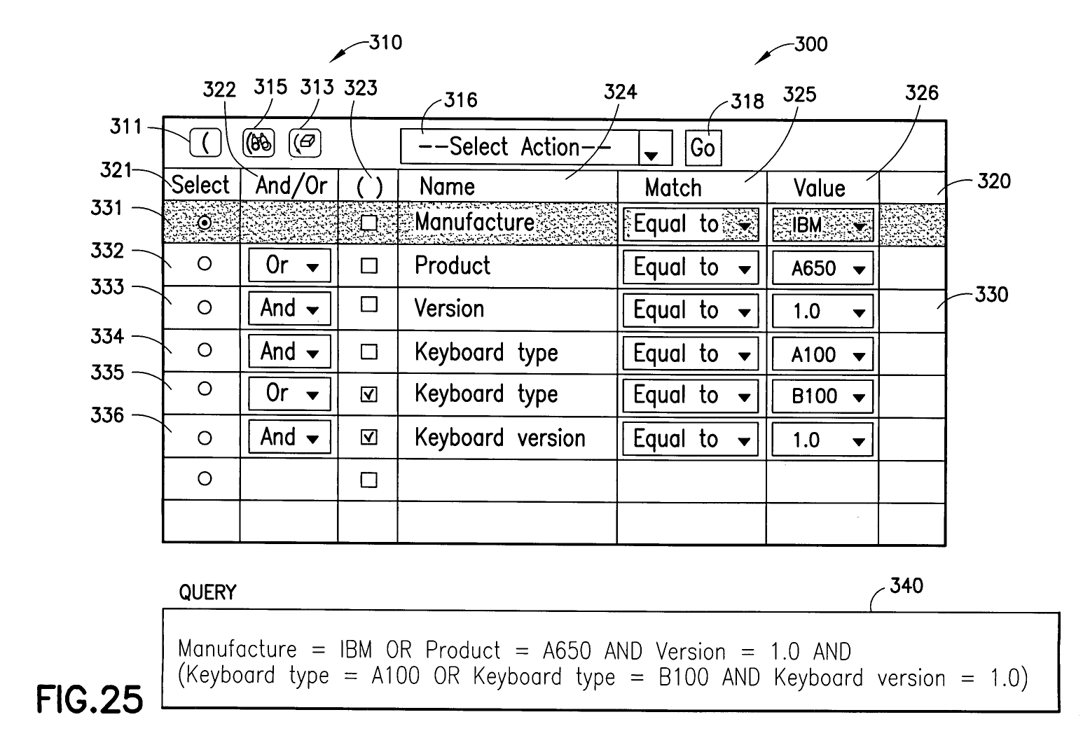

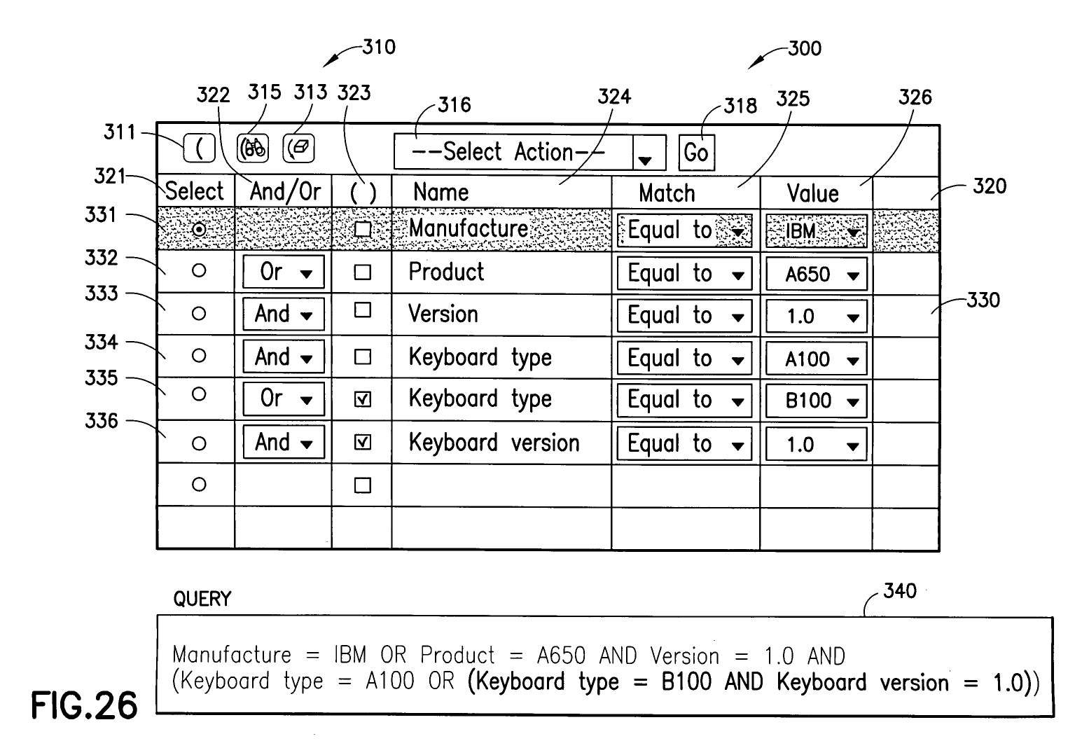

FIGS. 24-26 depict how a second level of parentheses can be added to an expression. FIG. 24 depicts the interactive tabular query interface as displaying an expression already containing a single-level parenthetical expression. FIG. 25 depicts the appearance of the interactive tabular query interface 300 after the user has selected the two component expressions that will be combined into an embedded parenthetical expression to be contained within the original parenthetical expression. As is apparent, checks now appear in the parentheses checkbox column 323 in the rows 335, 336. Next, the user selects the add parentheses icon 311 from the parentheses toolbar 310 and, as shown in FIG. 26, the new embedded parenthetical expression “(Keyboard type=B100 AND Keyboard version=1.0)” now appears. In the example shown in FIG. 26, the user also has selected the find parenthetical expression function using the parenthesis-binocular icon 315 to highlight the position of the new embedded parenthetical expression within the overall expression.

Thus it is seen that the foregoing description has provided by way of exemplary and non-limiting examples a full and informative description of the best methods and apparatus presently contemplated by the inventors for implementing parenthetical-expression capability in interactive tabular query interfaces. One skilled in the art will appreciate that the various embodiments described herein can be practiced individually; in combination with one or more other embodiments described herein; or in combination with interactive tabular query interfaces differing from those described herein. Further, one skilled in the art will appreciate that the present invention can be practiced by other than the described embodiments; that these embodiments are presented for the purposes of illustration and not of limitation; and that the present invention is therefore limited only by the following claims.

We claim:

1. A signal-bearing medium tangibly embodying a program of machine-readable instructions executable by a digital processing apparatus of a computer system to perform operations controlling a graphical user interface system, the operations comprising:
displaying an interactive tabular query interface on a display of the computer system, wherein the interactive tabular query interface comprises:
a table field for displaying logical expressions comprised of logical operators, operands and grouping elements, wherein the logical expressions, when taken together, comprise a search query;
a logical operator entry facility to enter logical operators in the table field;
an operand entry facility to enter operands in the table field, wherein the operands will be operated on by the operators; and
an expression grouping facility to group at least two logical expressions entered in the table field together into a grouped expression using grouping elements;
receiving commands corresponding to selections of logical operators, operands and grouping elements for display in selected locations in the table field; and
displaying selected logical operators, operands and grouping elements in the selected locations in the table field.

2. The signal-bearing medium of claim 1, wherein the grouping elements comprise parentheses.

3. The signal-bearing medium of claim 1, wherein the expression grouping facility further comprises:
an embedded expression grouping facility to formulate embedded grouped expressions set off by at least two levels of grouping elements.

4. The signal-bearing medium of claim 1, wherein the interactive tabular query interface further comprises:
a grouping element removal facility to logically un-combine at least two logical expressions that have been joined into a grouped expression.

5. The signal-bearing medium of claim 1, wherein the interactive tabular query interface further comprises:
a preview window to display at least a portion of the search query in a logical expression format comprised of operators, operands and grouping elements.

6. A computer system for displaying an interactive tabular query interface having expression grouping capability, the computer system comprising:
at least one memory to store at least one program of machine-readable instructions, where the at least one program performs operations to display the interactive tabular query interface when executed;
a computer display device for displaying the interactive tabular query interface;
an input device for interacting with the interactive tabular user interface; and
at least one processor coupled to the at least one memory, computer display and input device, where the at least one processor performs at least the following operation when the at least one program is executed:
displaying the interactive tabular query interface, where the interactive tabular query interface comprises:
a table field for displaying logical expressions comprised of logical operators, operands and grouping elements, wherein the logical expressions, when taken together, comprise a search query;
a logical operator entry facility to enter logical operators in the table field;
an operand entry facility to enter operands in the table field, wherein the operands will be operated on by the operators; and
an expression grouping facility to combine at least two logical expressions entered in the table field into a grouped expression using grouping elements.

7. The computer system for displaying an interactive tabular query interface of claim 6, wherein the expression grouping facility further comprises:
an embedded expression grouping facility to formulate embedded grouped expressions set off by at least two levels of grouping elements.

8. The computer system for displaying an interactive tabular query interface of claim 6, wherein the interactive tabular query interface further comprises:
a preview window to display at least a portion of the search query in a logical expression format comprised of operators, operands and grouping elements.

9. The computer system for displaying an interactive tabular query interface of claim 8, wherein the interactive tabular query interface further comprises:
a grouped expression location facility to highlight a particular grouped expression comprising, in part, the search query, wherein to highlight the particular grouped expression graphically emphasizes the position of the particular grouped expression within the search query when the search query is displayed in the preview window.

10. The computer system for displaying an interactive tabular query interface of claim 9, wherein the grouped expression location facility successively highlights each level of a multi-level grouped expression in which the particular grouped expression is incorporated in response to successive requests by the user.

11. The computer system for displaying an interactive tabular query interface of claim 6, wherein the expression grouping facility comprises a parentheses entry facility, the grouping elements comprise parentheses, and the grouped expressions comprise parenthetical expressions.

12. The computer system for displaying an interactive tabular query interface of claim 11, wherein:
the table field further comprises a plurality of cells organized in rows and columns, wherein individual logical expressions comprising the search query are entered in the rows of the table field by using the logical operator, operand and parentheses entry facilities to enter operators, operands and parentheses in the cells of the rows, and wherein the columns of the table field correspond to particular logical operators, operands or parentheses, and wherein an open parentheses column for indicating presence of open parentheses is positioned toward the left portion of the table field and a close parentheses column for indicating the presence of close parentheses is positioned toward the right portion of the table field; and wherein
the parentheses entry facility further comprises a toolbar comprising an open parenthesis icon and a close parenthesis icon; and
whereby parentheses are entered in cells in one of the open parentheses column or close parentheses column by selecting a cell in one of these two columns and by selecting the parenthesis icon in the toolbar corresponding to that parentheses column, wherein the appropriate parenthesis symbol is then graphically depicted in the selected cell position.

13. The computer system for displaying an interactive tabular query interface of claim 11, wherein the parentheses entry facility further comprises:
an embedded parentheses entry facility to formulate embedded parenthetical expressions.

14. The computer system for displaying an interactive tabular query interface of claim 12 further comprising:
a parenthetical expression removal facility to logically un-combine at least two logical expressions that have been joined in a parenthetical expression, wherein the parenthetical expression removal facility comprises a remove parenthesis icon in the toolbar,
whereby a parenthetical expression is removed by successively selecting cell positions containing the open and close parenthesis to be removed in the open parentheses and close parentheses columns and by selecting the remove parenthesis icon after the appropriate cell position has been selected.

15. The computer system for displaying an interactive tabular query interface having parenthetical expression capability of claim 11, wherein:
the table field further comprises a plurality of cells organized in rows and columns, wherein individual logical expressions comprising the search query are entered in the rows of the table field by using the logical operator entry, operand entry and parentheses entry facilities to enter operators, operands and parenthetical expressions in the cells of the rows, and wherein the columns of the table field correspond to particular logical operators, operands and a parenthetical expression checkbox column for indicating which logical expressions entered in the rows of the table field have been joined in a parenthetical expression; and wherein
the parentheses entry facility further comprises a toolbar comprising an parenthetical expression icon; and
whereby parenthetical expressions are formulated by first entering a check in the parenthetical expression checkbox column in each of the rows containing logical expressions to be joined into a parenthetical expression and then by clicking the parenthetical expression icon in the toolbar.

16. The computer system of claim 6 further comprising:
at least one database to be searched using a query formulated with the interactive tabular query interface.

17. The computer system of claim 16 wherein the at least one database is accessed over the internet.

18. The computer system of claim 6 further comprising:
a search engine coupled to the at least one processor, wherein the search engine searches databases over the internet with queries formulated using the interactive tabular query interface.

19. The computer system of claim 6 further comprising:
means for saving the search query formulated with the interactive tabular query interface to the at least one memory for later recall.

20. A user interface control system method comprising:
displaying an interactive tabular query interface having expression grouping capability, the interactive tabular query interface comprising:
a table field for displaying logical expressions comprised of logical operators, operands and grouping elements, wherein the logical expressions, when taken together, comprise a search query;
a logical operator entry facility to enter logical operators in the table field;
an operand entry facility to enter operands in the table field, wherein the operands will be operated on by the operators; and
a grouping element entry facility to combine at least two logical expressions entered in the table field into a grouped expression using grouping elements;
receiving commands corresponding to selections of logical operators, operands and grouping elements for display in selected locations in the table field; and
displaying selected logical operators, operands and grouping elements in the selected locations in the table field.

21. The user interface control system method of claim 20, where the grouping elements comprise parentheses.

22. The user interface control system method of claim 20, wherein the method further comprises:
formulating a database query with the interactive tabular query interface.

23. The user interface control system method of claim 20, wherein the method further comprises:
performing a database search with a query formulated using the interactive tabular query interface.
